(19) United States
(12) Patent Application Publication
(10) Pub. No.: US 2013/0342562 A1
(43) Pub. Date: Dec. 26, 2013

(54) Visual Accessibility for Vision Impaired

(71) Applicant: Peter Rae Shintani, San Diego, CA (US)

(72) Inventor: Peter Rae Shintani, San Diego, CA (US)

(21) Appl. No.: 13/532,945

(22) Filed: Jun. 26, 2012

(51) Int. Cl. G09G 5/02

(52) U.S. Cl. 345/593

(57) ABSTRACT

A method involves presenting a viewer of images on an electronic display with a plurality of images each of which displays an ordered range of intensities of colors for each of a plurality of color families; providing the viewer with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and displaying images on the electronic display, where the displayed images are compensated using the user selected gamma correction factors for each of the plurality of color families. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

People with visual impairments often have difficulty viewing a television display. When a person is visually impaired by any type of full or partial colorblindness or a person having a color vision impairment, it can be difficult to distinguish color details in a television image, and contrast between certain colors can also make viewing difficult.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is flow chart of an example of a process consistent with certain embodiments of the present invention.

FIG. 2 is an example screen shot of a television menu system consistent with certain embodiments of the present invention.

FIG. 3 is an example of an implementation of a screen shot for selecting a gamma function for a family of red color samples consistent with certain embodiments of the present invention.

FIG. 4 is an example of a family of curves representing various red gamma functions consistent with certain embodiments of the present invention.

FIG. 5 is an example of an implementation of a screen shot for selecting a gamma function for a family of green color samples consistent with certain embodiments of the present invention.

FIG. 6 is an example of a family of curves representing various green gamma functions consistent with certain embodiments of the present invention.

FIG. 7 is an example of an implementation of a screen shot for selecting a gamma function for a family of blue color samples consistent with certain embodiments of the present invention.

FIG. 8 is an example of a family of curves representing various blue gamma functions consistent with certain embodiments of the present invention.

FIG. 9 is an example of a block diagram of a display system consistent with certain embodiments of the present invention.

FIG. 10 is an example of a flow chart depicting operation of a display system in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a script, a program module, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. In this discussion, the use of the term “Program” is generally consistent with that of the MPEG-2 Systems standard (ISO/IEC 13818-1). An MPEG-2 Program has the associated Elementary Stream components, such as for example one video Elementary Stream and one or more audio Elementary Streams. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

A person with impairment in color perception (such as a person having full or partial colorblindness, may find viewing a television or other electronic display to be difficult. This person's viewing experience can sometimes be enhanced by allowing him or her to exercise control over the gamma compensation for individual colors in each of a plurality of color families (e.g., primary colors used by the display). A color family for purposes of this document refers to a set of colors presented to a viewer with the colors differing from one another only by having varying intensity, or in the case of a primary color having varying brightness. Thus, colors in a primary color family may have different intensity, and as the gamma correction curve is altered, an emphasis in the size of steps between adjacent intensities may be modified such that the step size is larger or smaller at lower intensities than at higher intensities. The viewer may have an improved viewing experience if the gamma correction curve is altered so that the viewer perceives variations in color intensity from lowest intensity to highest intensity to take place in approximately equal steps. The display of images on a video display can then be altered using the altered gamma correction curve so as to present a potentially more easily viewable image to the viewer.

In the present application, illustrative examples are presented using a color family of red, green and blue primary colors. However, in other implementations, different color families and different sets of primary colors may be utilized without deviation from the present teachings. While the red, green and blue primary colors are most common on a television display, there are alternative primary color systems. Some such systems add more primaries and/or change the primary colors. This allows more selective control of colors since there are more primary colors to control. For example if the user cannot see green, the use of the green primary is moot. If an alternative primary system is used, where there are for example 6 primaries, a different primary color can be used in place of green. At present, not many video systems use expanded sets of primary colors, it is likely that future sets of primary colors may be expanded for use in television displays where six, eight or more primary colors may be used. For purposes of this document, any collection of primary colors can be considered to be a patent family within the meaning of that term herein. In such cases, the same or similar techniques can be applied as is explained for the case of three primary colors as used for a primary example in this disclosure.

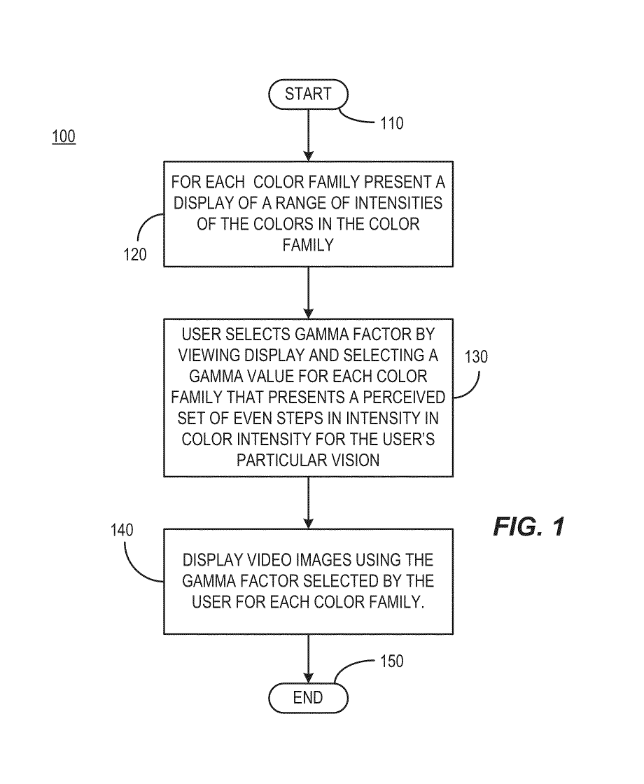

Turning now to FIG. 1, a process 100 is depicted in which a viewer is permitted to alter the gamma curve (without necessarily knowing what they are doing) so as to improve the presentation of a set of colors. The process starts at 110. In general, the process is devised to allow the user to view a set of colors one at a time, preferably, but not necessarily, the primary colors are viewed one at a time. For each primary color (for example) a set of color samples are displayed side by side or otherwise adjacent with each color being presented in such a manner that the intensity or brightness of the color is incremented in approximately equal steps from one to the next. In this manner, the particular color displayed provides the viewer with a range of colors from lowest to highest intensity in equal increments at 120. This display is a nominal setting that is displayed to the viewer. But, given that the viewer's color perception is impaired, he or she may perceive the steps as being unequal, or may perceive no difference at all in certain of the adjacent color samples.

At 130, the user is provided with a control such as a slider that is operated by use of a pointing device or a remote controller that permit the user to adjust the gamma function used to display the color samples for that particular color. The gamma function can be altered so as to be weighted toward higher or lower than nominal color intensity until the viewer perceives the colors to have approximately equal spacing from lowest to highest intensity. When this setting is achieved, the viewer has highest likelihood of being able to discern between the varying intensity of that particular color family (e.g., primary color). This process is repeated for multiple color families such as the red, green and blue primary colors used in a typical video display. Once this process is completed, the calibration process is over and the images are displayed on the video display at 140 using the multiple separate gamma values selected by the viewer and the process ends at 150.

It is likely that the viewer will perceive that certain colors (particularly those made up of combinations of primary colors) are shifted away from their true color. For example, magentas may shift toward purple or vice versa. The user can determine if this is preferable in terms of a pleasing visual experience or not and change the display back to its defaults if desired. Since the present process involves accommodating a viewer's perception, there is variability in whether the viewer's perception is enhanced or degraded and will vary on a case by case basis. Of course, the viewer can always carry out the process 100 again to establish a more moderate degree of modification where the steps in intensity are not perceived to be as equal in order to adjust for color shifts and the like if desired.

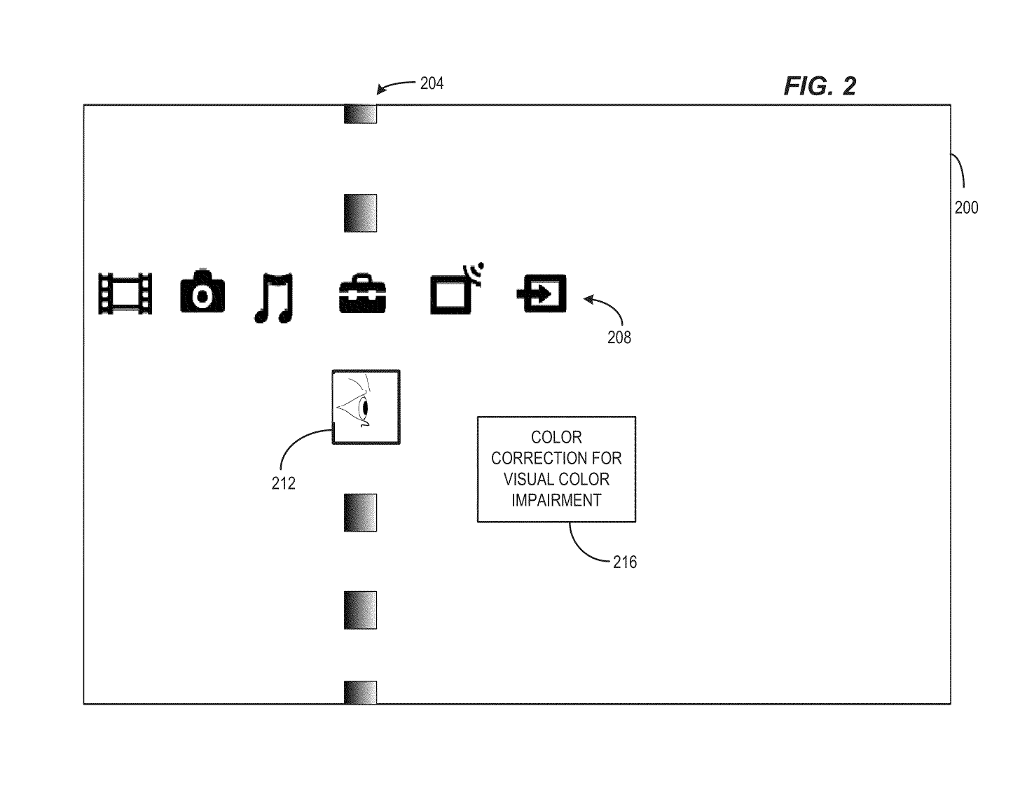

Referring now to FIG. 2, an example implementation of the process described above is depicted. In order to enter this process, the user may be queried at the time of initial television (TV) setup if he or she wishes to attempt to compensate for a color vision impairment. But, it is likely best to allow the user to make such a selection after having an opportunity to view the TV display in its standard configuration before altering the display. In this figure, a screen display is depicted in which a display 200 has been placed in a menu configuration. In this example, the menu depicted is a cross-media bar (XMB) menu system such as those used in many TVs made by Sony Corporation. The user enters such a menu system by invoking a menu command from the remote controller. In this menu system a horizontal menu bar 204 is crossed by a vertical menu bar 208 with a menu selection just below the intersection (selection 212) being “in focus”. The user navigates to a position on the menu system in which the desired action is in focus and presses the select or enter button to enter the menu selection. In this example, there may appear a message 216 to provide the viewer with more information about the menu selection. In this case, icon 212 represents color correction for those with color visual impairments.

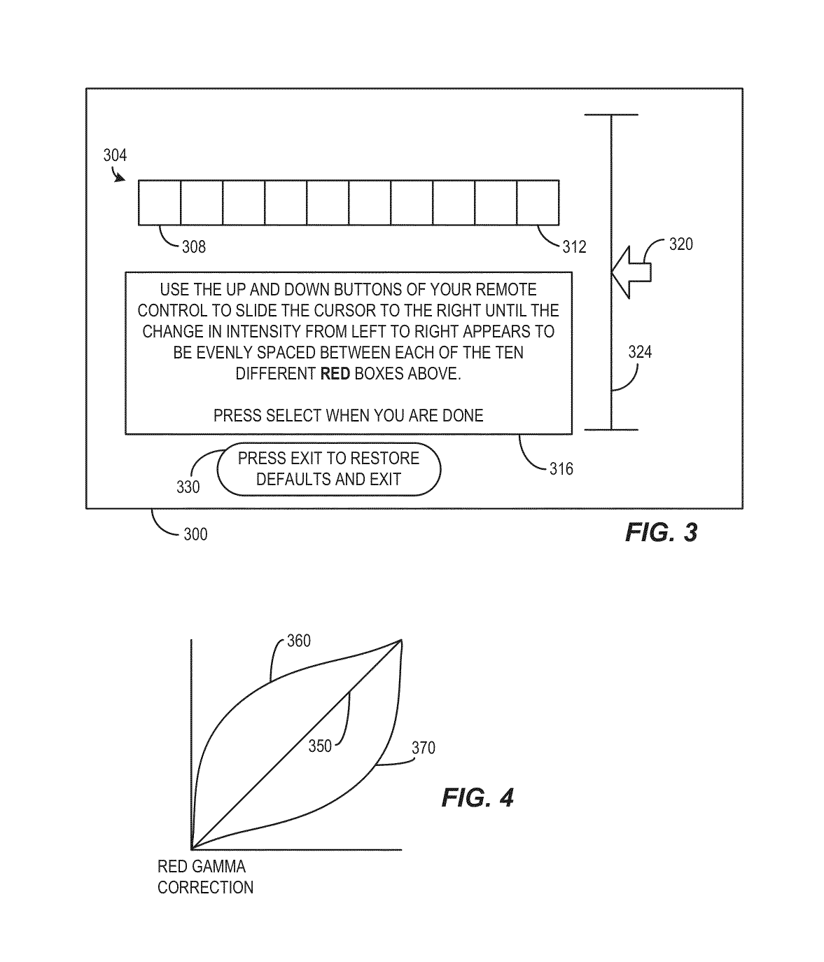

In this implementation, when the user selects icon 212, the display proceeds to 300 as shown in FIG. 3. In this example implementation, display 300 displays a set of ten color sample boxes 304 that display varying intensities of the primary color red ranging from the lowest intensity at 308 to the highest intensity at 312. More or fewer color sample boxes could be used without limitation. A text box 316 provides the viewer with instructions to utilize the remote control cursor control buttons to move the slider cursor 320 up or down bar 324 to change the relative intensity of the color sample blocks until they appear evenly spaced in intensity. It is noted that those with severe color impairment may see no difference. The user can also be given instructions on how to exit the process if they choose at 330.

As the user moves the slider cursor up or down from a nominal central position, the gamma correction curve shown in FIG. 4 will be warped from a nominal position (shown for illustrative purposes as a line) 350 to a curve 360 resembling the shape of an exponential which emphasizes lower values of intensity or to a curve 370 that emphasizes higher values of intensity. This movement can be through several increments of intermediate curves. In any case, the user with impaired color vision will hopefully perceive a distinction in the step size between adjacent color intensities and can warp the color intensity so as to more closely approximate what would be seen with normal color vision.

Once this has been accomplished, the viewer presses the select button to save the gamma function values that are to be used for the color being adjusted. The values of the gamma function for this color (red) can then be used to adjust the values of intensity of reds being displayed in video program material such as television programs.

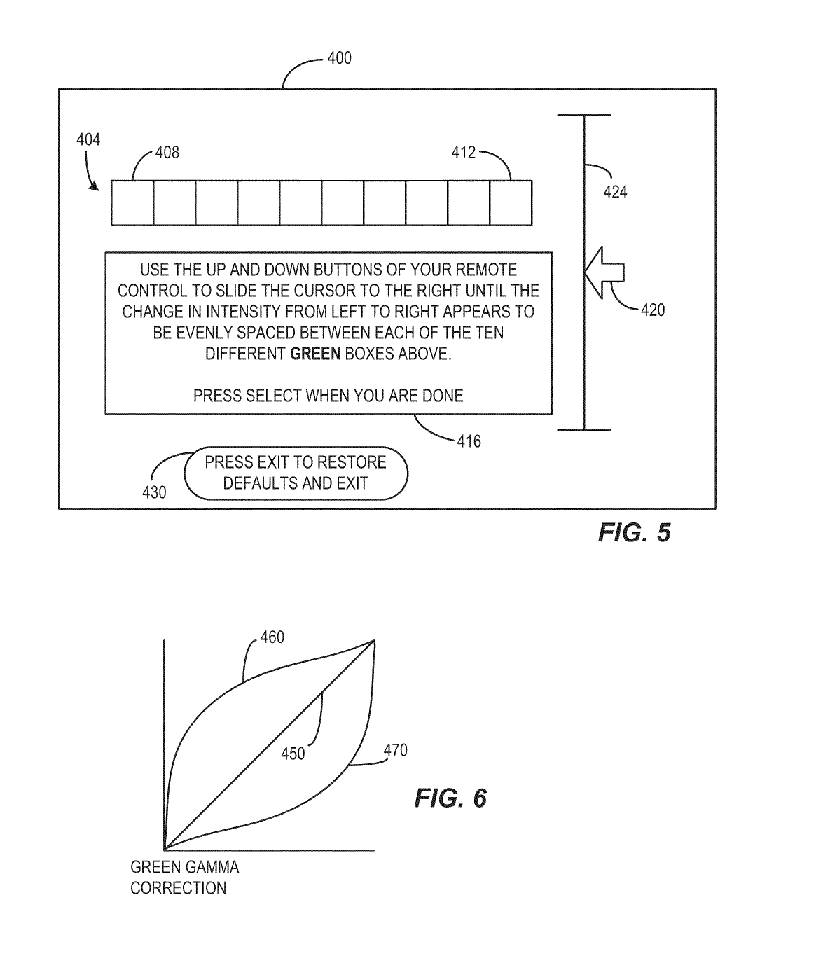

After the user selects the first gamma function, a second may be displayed. In this example, the three primary colors red, green and blue are sequentially adjusted by the user. In this implementation, when the user selects the red gamma function from display screen 300, the display proceeds to 400 as shown in FIG. 5. In this example implementation, display 400 displays a set of ten color sample boxes 404 that display varying intensities of the primary color green ranging from the lowest intensity at 408 to the highest intensity at 412. More or fewer color sample boxes could be used without limitation. A text box 416 provides the viewer with instructions to utilize the remote control cursor control buttons to move the slider cursor 420 up or down bar 424 to change the relative intensity of the color sample blocks until they appear evenly spaced in intensity. It is noted that those with severe color impairment may see no difference. The user can also again be given instructions on how to exit the process if they choose at 430.

As the user moves the slider cursor up or down from a nominal central position, the gamma correction curve shown in FIG. 6 will be warped from a nominal position (shown for illustrative purposes as a line) 450 to a curve 460 resembling the shape of an exponential which emphasizes lower values of intensity or to a curve 470 that emphasizes higher values of intensity. This movement can be through several increments of intermediate curves. In any case, the user with impaired color vision will hopefully perceive a distinction in the step size between adjacent color intensities of green and can warp the color intensity so as to more closely approximate what would be seen with normal color vision.

Once this has been accomplished, the viewer again presses the select button to save the gamma function values that are to be used for the color being adjusted. The values of the gamma function for this color (green) can then be used to adjust the values of intensity of greens being displayed in video program material such as television programs.

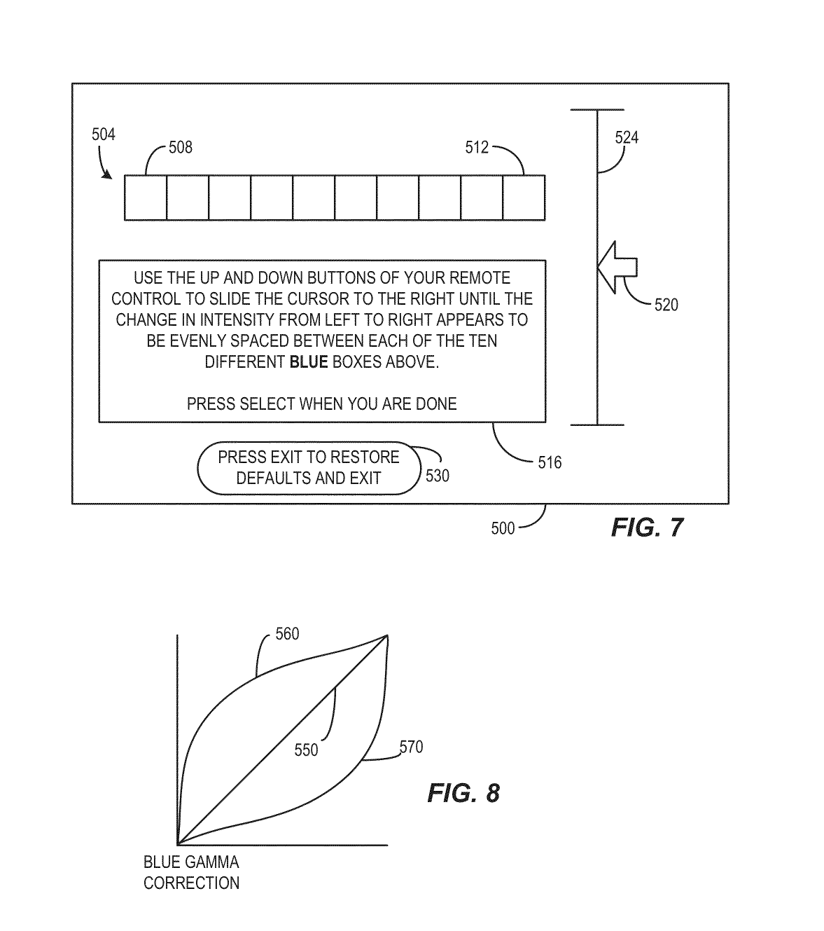

After the user selects the second gamma function, a third may be displayed. In this example, the final of the three primary colors red, green and blue that are sequentially adjusted by the user is displayed. Thus, in this implementation, after the user selects the red gamma function from display screen 300 and the green gamma function from display screen 400, the display proceeds to 500 as shown in FIG. 7. In this example implementation, display 500 displays a set of ten blue color sample boxes 504 that display varying intensities of the primary color blue ranging from the lowest intensity at 508 to the highest intensity at 512. More or fewer color sample boxes could be used without limitation. A text box 516 provides the viewer with instructions to utilize the remote control cursor control buttons to move the slider cursor 520 up or down bar 524 to change the relative intensity of the blue color sample blocks until they appear evenly spaced in intensity. It is noted that those with severe color impairment may see no difference. The user can also again be given instructions on how to exit the process if they choose at 530.

As the user moves the slider cursor up or down from a nominal central position, the gamma correction curve shown in FIG. 8 will be warped from a nominal position (shown for illustrative purposes as a line) 550 to a curve 560 resembling the shape of an exponential which emphasizes lower values of intensity or to a curve 570 that emphasizes higher values of intensity. This movement can be through several increments of intermediate curves. In any case, the user with impaired color vision will hopefully perceive a distinction in the step size between adjacent color intensities of blue and can warp the color intensity so as to more closely approximate what would be seen with normal color vision.

Once this has been accomplished, the viewer again presses the select button to save the gamma function values that are to be used for the blue color gamma function being adjusted. The values of the gamma function for this color (blue) can then be used to adjust the values of intensity of blues being displayed in video program material such as television programs. Once all three of the primary colors used in this example have been selected, they are individually applied to warp the color space used in driving the video display so as to attempt to compensate for the visual color impairment. It is again noted that the viewer will have to be the judge of whether the change is preferable or not and it is noted that combinations of colors will be affected so as to shift the colors, which may or may not be acceptable to the viewer.

It will be appreciated by those skilled in the art that the presentation of three individual screens for adjusting three primary colors may be condensed into a single screen without deviating from the teachings herein, and other representations of the color samples may be used without limitation (e.g., a fan or wheel or arc of colors separated into individual intensities).

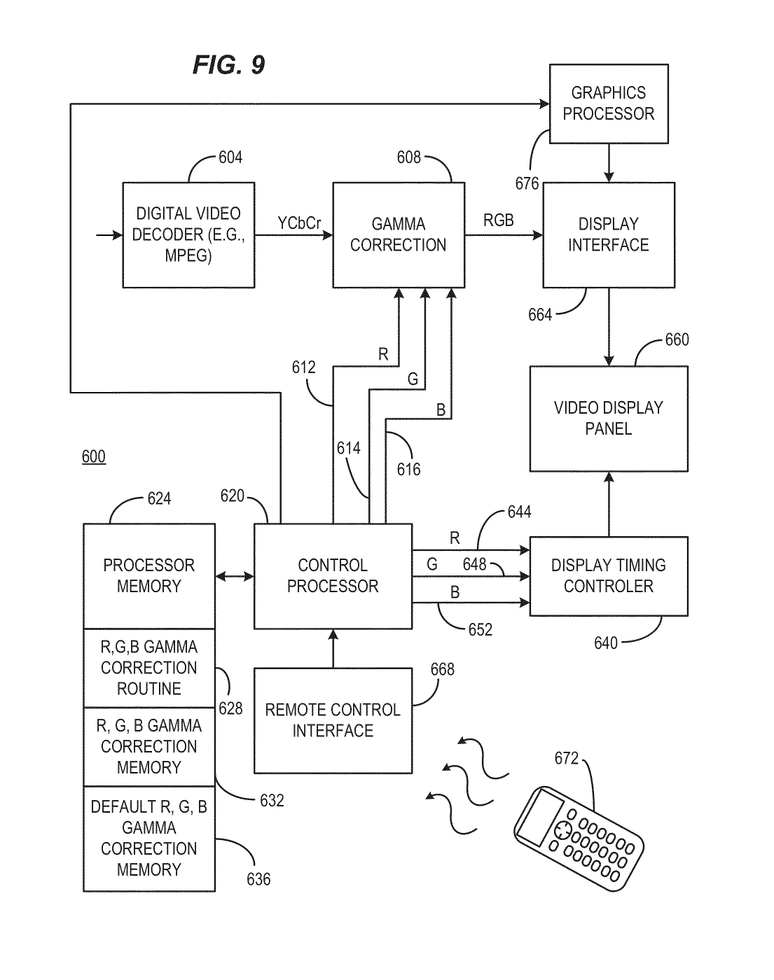

Once the color gamma values are established, they can be saved to memory and used to alter the video signal being displayed on a video display, e.g., for a television or other device with a video display. One example system 600 for accomplishing this is depicted in block diagram form in FIG. 9, in which an encoded video signal (e.g., MPEG encoded video) is received at a digital video decoder 604 where the digital video is converted, for example, to YCbCr color space. This video signal is then modified at 608 by application of gamma correction in a known manner to account for any display characteristics, but further to utilize the gamma functions selected by the user as described previously. In this example, this entails using three separate gamma values for red, green and blue respectively which are represented by connections 612, 614 and 616 respectively.

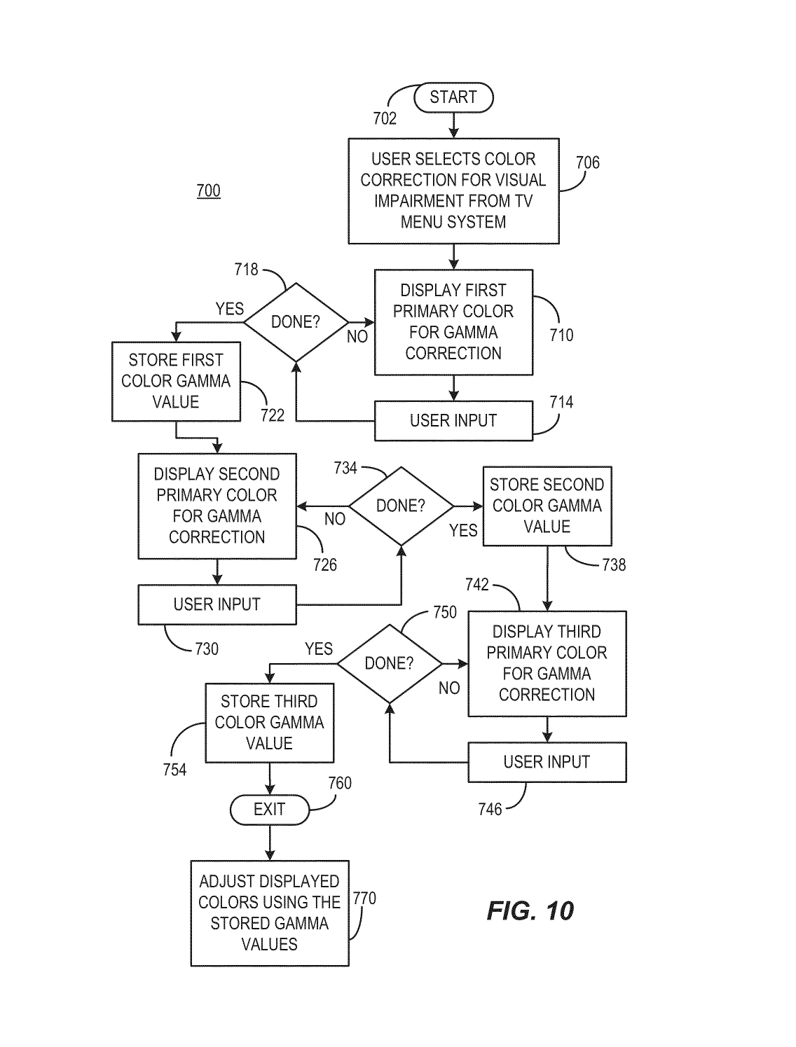

In this implementation, a control processor 620 for the TV is coupled to memory/storage devices 624 of any suitable configuration that stores the R,G,B gamma correction routine 628 that implements the process previously discussed (and as will be discussed further in connection with FIG. 10) as well as stores the gamma correction values selected by the user at R,G,B gamma correction memory 632. The default gamma correction values are also stored at 636. Memory/storage 624 can also store operating system, menu system and other control routines as are normally utilized to control and oversee operation of a digital TV, but which are not depicted to simplify the drawing.

The control processor 620 can modify the gamma functions being used by retrieving the user selected gamma functions from memory 632 and providing those values in the form of tables, equations or any other suitable format to the gamma correction circuit 608. Additionally, or alternatively, the gamma correction values selected by the user can be used to modify the operation of a display timing controller circuit 640 by providing similar information for the R,G,B gamma signals as represented by 644, 648, and 652 respectively. The display timing controller 640 can use this information to determine how each pixel in a video display panel 660 such as an LCD display panel is displayed by modulation of the timing and intensity of each pixel as it is lighted to achieve a similar or complementary effect in modification of the color values to be presented on the display.

Once the gamma correction has been applied at 608, an RGB signal is produced with the gamma correction which then is received by a display interface 664 that drives the display 660 with colors that are modified by the user selected gamma values. Control processor 620 also receives input signals from a remote control interface 668 in order to receive instructions from the remote controller 672 during the process of selection of the gamma functions. Control processor 620 also communicates with a graphics processor 676 to produce renderings of menu system screens, program guides, menus and the screen displays 300, 400 and 500 which are then supplied to the display interface 664 for presentation on the display 660.

FIG. 10 depicts a process flow chart for an example process 700 starting at 702 such as that described earlier in connection with the example screen shots. At 706, the user selects a color correction function for visual impairment from the TVs menu system. This results in display of a first primary color (or other color family) with varying degrees of intensity for gamma correction at 710. The user experiments with the various gamma settings at 714 until he or she is done and enters the selection to complete the first color gamma function selection at 718. The first color gamma value (curve, chart, table, graph, map, etc.) is stored at 722 and the second primary color or other color family of varying degrees of color intensity is displayed at 726. The user again adjusts the color gamma value at 730 until satisfied at 734 after which the second color gamma function is stored at 738. The third primary color or other color family of varying degrees of color intensity is then displayed at 742. The user again adjusts the color gamma value at 746 until satisfied at 750 after which the third color gamma function is stored at 754. This process of gamma selection then ends at 760 after which the display is operated at 770 in such a manner as to modify the colors using the color gamma values selected by the user and stored at 722, 738 and 754.

While the example presented shows ten steps of color intensity, it may be simpler for the user to present fewer steps. Similarly, while the slider cursor implies a continuous range, this is not necessarily the case since, for example, only three or five possible selections may be provided in order to further simplify the user's experience with estimating approximate equal steps in color intensity, which in the case of color vision impaired may be a difficult task which would be best simplified. Those skilled in the art will appreciate upon consideration of the present teachings that many variations and modifications are possible.

Thus, a method consistent with certain implementations involves presenting a viewer of images on an electronic display with a plurality of images each of which displays an ordered range of intensities of colors for each of a plurality of color families; providing the viewer with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and displaying images on the electronic display, where the displayed images are compensated using the user selected gamma correction factors for each of the plurality of color families.

A non-transitory computer readable storage device consistent with certain implementations stores instructions which, when executed on one or more programmed processors, carry out a method of presenting a viewer of images on an electronic display with a plurality of images each of which displays an ordered range of intensities of colors for each of a plurality of color families; providing the viewer with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and storing the user selected gamma factors.

An apparatus consistent with certain implementations has an electronic display and a display driver circuit that drives the display. A programmed processor is configured to carry out a process of: obtaining a plurality of user selected color gamma values for each of a plurality of color families, where the user selected color gamma values are selected by the user by presenting the user with images on the electronic display with a plurality of images each of which displays an ordered range of intensities of colors for each of a plurality of color families; providing the user with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and displaying images on the electronic display, where the displayed images are compensated using the user selected gamma correction factors for each of the plurality of color families.

In certain implementations of the above, the color families comprise families of primary colors. In certain implementations, the ordered range of intensities of colors is presented on a display as a linear set of boxes with each successive box having increased color intensity. In certain implementations, the plurality of color families comprise red, green and blue primary color families. In certain implementations, a color gamma factor is selected for each of at least three primary colors. In certain implementations, the displaying comprises compensating the images using the user selected gamma correction factors at a gamma correction circuit. In certain implementations, the displaying comprises compensating the images using the user selected gamma correction factors at a display timing circuit. In certain implementations, the displaying comprises compensating the images using the user selected gamma correction factors at a gamma correction circuit and at a display timing circuit.

Those skilled in the art will recognize, upon consideration of the above teachings, that certain of the above exemplary embodiments are based upon use of one or more programmed processors programmed with a suitable computer program. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. The term “non-transitory” is intended only to exclude propagating waves and signals and the like but not volatile memory or memory that can be erased or rewritten. All such alternative storage devices should be considered equivalents.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping, time outs, etc. can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

While certain illustrative embodiments have been described, it is evident that many alternatives, modifications, permutations and variations will become apparent to those skilled in the art in light of the foregoing description.

What is claimed is:

1. A method, comprising:
presenting a viewer of images on an electronic display with a plurality of images each of which displays an ordered range of intensities of colors for each of a plurality of color families;
providing the viewer with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and
displaying images on the electronic display, where the displayed images are compensated using the user selected gamma correction factors for each of the plurality of color families.

2. The method according to claim 1, where the color families comprise families of primary colors.

3. The method according to claim 1, where the ordered range of intensities of colors is presented on a display as a linear set of boxes with each successive box having increased color intensity.

4. The method according to claim 1, where the plurality of color families comprise red, green and blue primary color families.

5. The method according to claim 1, where a color gamma factor is selected for each of at least three primary colors.

6. The method according to claim 1, where the displaying comprises compensating the images using the user selected gamma correction factors at a gamma correction circuit.

7. The method according to claim 1, where the displaying comprises compensating the images using the user selected gamma correction factors at a display timing circuit.

8. The method according to claim 1, where the displaying comprises compensating the images using the user selected gamma correction factors at a gamma correction circuit and at a display timing circuit.

9. A non-transitory computer readable storage device storing instructions which, when executed on one or more programmed processors, carry out a method of:
presenting a viewer of images on an electronic display with a plurality of images each of which displays an ordered range of intensities of colors for each of a plurality of color families;
providing the viewer with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and
storing the user selected gamma factors.

10. The storage device according to claim 9, where the one or more processors is further instructed to display images on the electronic display, where the displayed images are compensated using the user selected gamma correction factors for each of the plurality of color families.

11. The storage device according to claim 9, where the color families comprise families of primary colors.

12. The storage device according to claim 9, where the ordered range of intensities of colors is presented on a display as a linear set of boxes with each successive box having increased color intensity.

13. The storage device according to claim 9, where the plurality of color families comprise red, green and blue primary color families.

14. The storage device according to claim 9, where a color gamma factor is selected for each of at least three primary colors.

15. The storage device according to claim 9, where the displaying comprises compensating the images using the user selected gamma correction factors at a gamma correction circuit.

16. The storage device according to claim 9, where the displaying comprises compensating the images using the user selected gamma correction factors at a display timing circuit.

17. The method according to claim 9, where the displaying comprises compensating the images using the user selected gamma correction factors at a gamma correction circuit and at a display timing circuit.

18. An apparatus, comprising:
an electronic display;
a display driver circuit that drives the display;
a programmed processor that is configured to carry out a process of:
obtaining a plurality of user selected color gamma values for each of a plurality of color families, where the user selected color gamma values are selected by the user by presenting the user with images on the electronic display with a plurality of images each of which displays an ordered range of intensities of colors for each of a plurality of color families;
providing the user with control over selection of a gamma correction factor for each of the plurality of color families so as to allow the viewer to select a gamma factor that presents an appearance of most equal steps in intensity change in each of the plurality of color families in order to compensate for a color vision impairment of the viewer; and
displaying images on the electronic display, where the displayed images are compensated using the user selected gamma correction factors for each of the plurality of color families.

19. The apparatus according to claim 18, where the color families comprise families of primary colors.

20. The apparatus according to claim 18, where the ordered range of intensities of colors is presented on a display as a linear set of boxes with each successive box having increased color intensity.

21. The apparatus according to claim 18, where the plurality of color families comprise red, green and blue primary color families.

22. The apparatus according to claim 18, where a color gamma factor is selected for each of at least three primary colors.

23. The apparatus according to claim 18, further comprising a gamma correction circuit, and where the displaying comprises compensating the images using the user selected gamma correction factors at a gamma correction circuit.

24. The apparatus according to claim 18, further comprising a display timing circuit, and where the displaying comprises compensating the images using the user selected gamma correction factors at a display timing circuit.

25. The apparatus according to claim 18, further comprising a gamma correction circuit and a display timing circuit, and where the displaying comprises compensating the images using the user selected gamma correction factors at a gamma correction circuit and at a display timing circuit.
